(19) United States
(12) Patent Application Publication
(10) Pub. No.: US 2016/0303624 A1
(43) Pub. Date: Oct. 20, 2016

(54) CHEMCIAL JUG WASHER AND DISPOSAL ASSEMBLY

(71) Applicant: Paul Thomas Hitchens, Hessel, MI (US)

(72) Inventor: Paul Thomas Hitchens, Hessel, MI (US)

(21) Appl. No.: 15/095,332

(22) Filed: Apr. 11, 2016

Related U.S. Application Data
(60) Provisional application No. 62/178,745, filed on Apr. 20, 2015.

(51) Int. Cl. B09B 3/00; B26F 1/24; B05B 13/06; B08B 9/34; B05B 1/20

(52) U.S. Cl. CPC B09B 3/0058; B08B 9/34; B05B 1/20; B05B 13/0609; B05B 13/0627; B26F 1/24

(57) ABSTRACT

A combination cleaning and disposal assembly for safely cleaning and rendering unusable a jug containing a hazardous chemical residue. A body supports a receiving chamber for receiving the jug. A manifold is supported by the body and has a plurality of spikes arrayed toward the jug. A pressurized fluid source is communicated to the manifold such that, upon an inter-displacement occurs between the manifold and the container, the spikes are caused to pierce the container, the pressurized fluid being caused to issue from the spikes to clean an interior of the container. A drain is located underneath the jug receiving chamber which collects and segregates the fluid contaminated with the chemical residue for securing disposal concurrent with removing and disposing of the now-cleaned and punctured jug.

### CROSS-REFERENCE TO RELATED APPLICATIONS

The present application claims the priority of U.S. Ser. No. 62/178,745, filed Apr. 13, 2015, the contents of which is incorporated herein in its entirety.

### FIELD OF THE INVENTION

The present invention relates generally to washing and disposal assemblies for plastic containers, such as containing residue of chemical or hazardous style waste. More specifically, the present invention teaches a self-contained combination chemical jug rinse and destruction/disposal assembly which provides for pressurized cleaning and concurrent puncturing destruction of the jug, following which the cleaned/destroyed jug is removed (such as for recycling) and the contaminated fluid rinse is transferred to a sealed tank/reservoir for safe disposal.

### BACKGROUND OF THE INVENTION

Many types of hazardous chemicals are contained within plastic style jugs or containers, such including but not limited to chemical filled jugs for industrial, pesticide or other applications. Current disposal protocol for emptied jugs (such as which container such chemical residue) is to utilize a hand-held garden hose and jug piercing/puncturing tool, as reuse of the jug is not practical as opposed to providing for destruction and/or secure and sanitary disposal. Aside from the user having to wear protective clothing and respiration gear, additional difficulties include the requirement of collecting the contaminated water rinse, such as which would otherwise cause drainage into the ground or public sewer.

One example of an existing apparatus for emptying and rinsing containers is depicted in U.S. Pat. No. 3,916,924, to McGowan, in which a member is inserted into and locked in the opening of the pesticide container. The member evacuates the contents of the container and rinses to render the container disposable.

Butler, U.S. Pat. No. 4,039,351, teaches a removable washer attachment including an insert with both exterior and interior container extending portions. The insert is fluid-tight sealed to the container opening with another seal provided between the bore and a suction tube inserted therein. Washing fluid is admitted into the bore and is channeled through passages into curved notches disposed in a lower segment of the interiorly depending container insert portion. The washing fluid is sprayed upwardly and contacts the inside top and side walls of the container or interiorly held disposable bag. The residue material is washed downwardly to the bottom of the container where it is removed through the suction tube.

WO 2012/031955, to Feistmantl Cleaning Systems GMBH, teaches a container cleaning system and method having a closable cleaning chamber, a nozzle system for cleaning a container to be cleans, and a charging means for introducing the containers into the cleaning chamber and for discharging the cleaned containers. A container drive means moves the container for cleaning of the its exterior by such that a relative movement between the outer wall of the container and the nozzle system is generated.

Other references of note include each of the washer with bio prevention cycle of Quddus, U.S. Pat. No. 7,753,009, the parts washer of Spencer, US 2015/0239016 and the beverage jug cleaning system of Clarkson, US 2015/0101286.

### SUMMARY OF THE INVENTION

The present invention teaches a combination cleaning and disposal assembly for safely cleaning and rendering unusable a jug containing a hazardous chemical residue. The assembly incorporates a frame, such including welded aluminum supports, containing an upper jug receiving chamber. A first loading tray provides for introduction of a contaminated jug into the receiving chamber.

A jug piercing manifold is positioned above the jug placed within the receiving chamber and includes any number of hollowed and fluid communicating spikes for successively impaling and pressure washing the container. A high pressure pump draws fresh water from a first proximately located tank or reservoir frame for communication, via one or more lines, to the impaling spikes forming the displacing manifold.

The pressurized fluid flows across the contaminated interior of the jug and then out through a bottom of the container (typically laying on its side) which has been completely through punctured by the pointed tips of the spikes. The floor of the jug receiving chamber may further exhibit a spaced grid or other apertured support surface which allows the tips of the spikes to pass unimpeded through the floor support to facilitate through drainage of the contaminated fluid.

The contaminated fluid subsequently drains into a second proximately located chemical rinse and storage tank for secure disposal. The cleaned and impaled/compressed jug is now rendered unusable and can be removed from the assembly, typically from a second jug removal tray located in communication with the receiving chamber on an opposite side from the first loading tray.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan view of the chemical jug washing and disposal assembly according to one non-limiting variant, with the interior of the frame depicted in cutaway to exhibit the jug receiving chamber and downwardly displaceable spike piercing manifold, along with both the first jug loading tray and second jug removal tray;

FIG. 2 is an enlarged plan view of the receiving chamber and illustrating the spike manifold in an intermediate puncturing position; and

FIG. 3 is a succeeding illustration to FIG. 2 showing the spikes in a fully descended and jug impaling condition in which the outflow drainage of contaminated fluid is shown descending through a bottom grate support associated with the receiving chamber prior to collecting within the rinse tank.

### DETAILED DESCRIPTION OF THE PREFERRED EMBODIMENTS

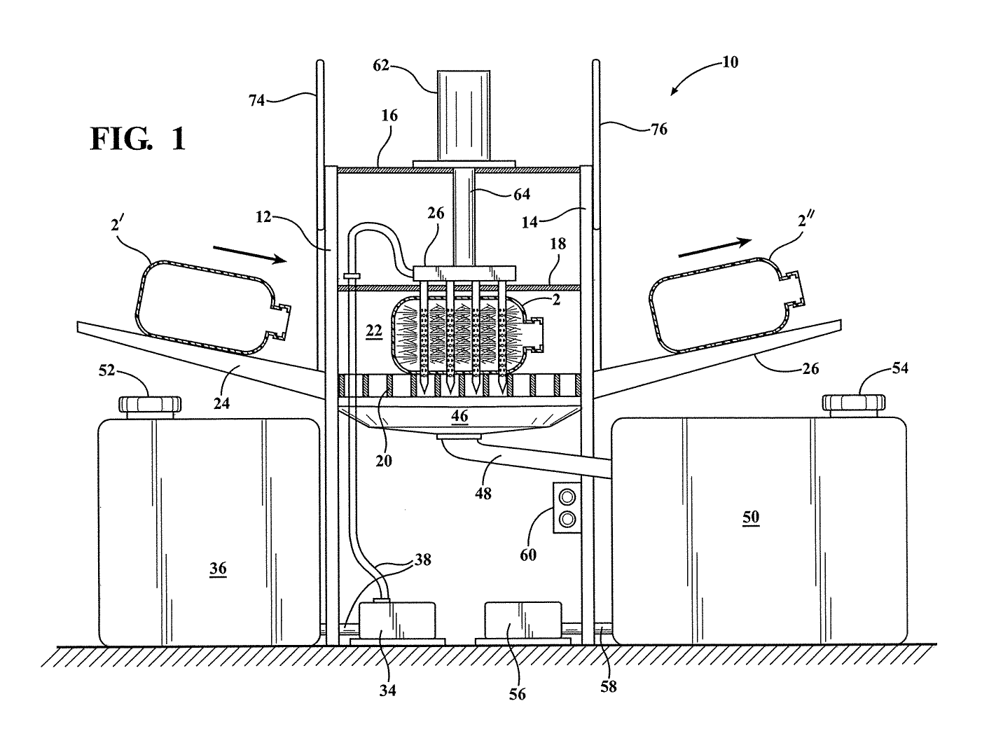

With reference to the attached illustrations, the present invention teaches a combination cleaning and disposal assembly, see generally at 10 in FIG. 1, for safely cleaning and rendering unusable a jug containing a hazardous chemical residue. The assembly incorporates a body, such as without limitation a frame including welded aluminum supports including in plan cutaway vertical extending supports 12, 14, et seq. and interconnecting horizontally spaced supports 16, 18, et seq. As shown, the body exhibits a generally rectangular configuration if viewed in three dimension however can further have any suitable shape.

As further shown, the body (or frame) includes a horizontally extending grate or other support 20 which is located a distance below the horizontal support surface 18, the space defined therebetween being a jug receiving chamber 22 within which is inserted a residue contaminated jug 2. A first loading tray 24 provides for introduction of a succeeding contaminated jug 2′ into the receiving chamber 22, with a second opposite extending loading or unloading tray 26 providing for removal of a preceding and cleaned/destroyed jug 2″ which is safe for disposal or recycling.

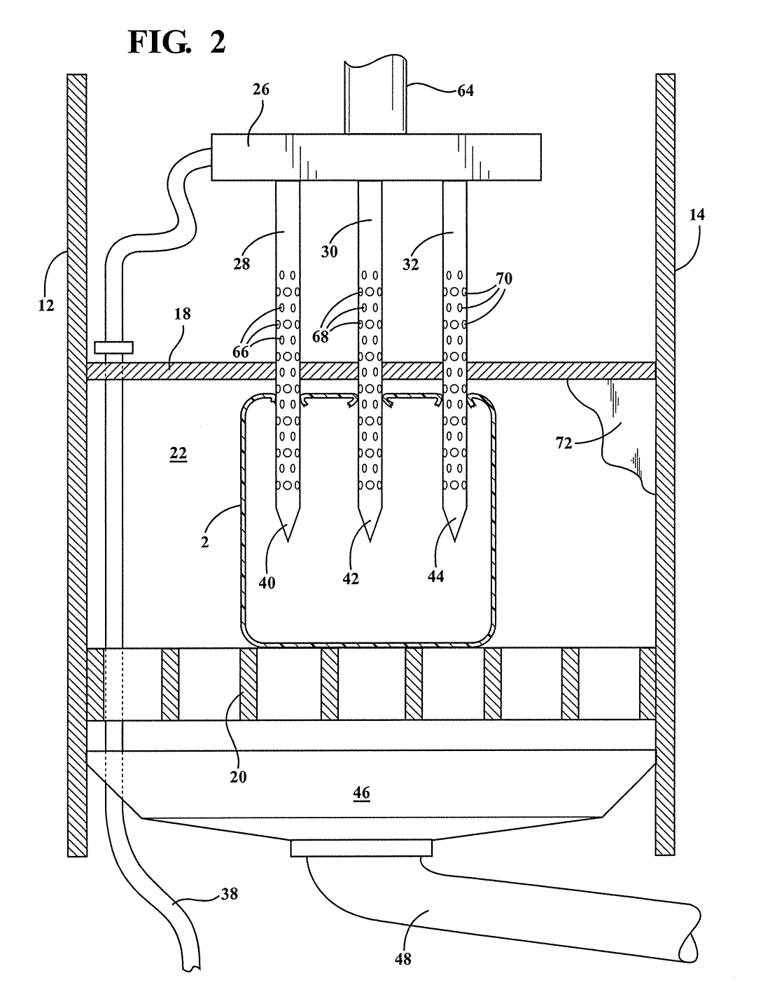

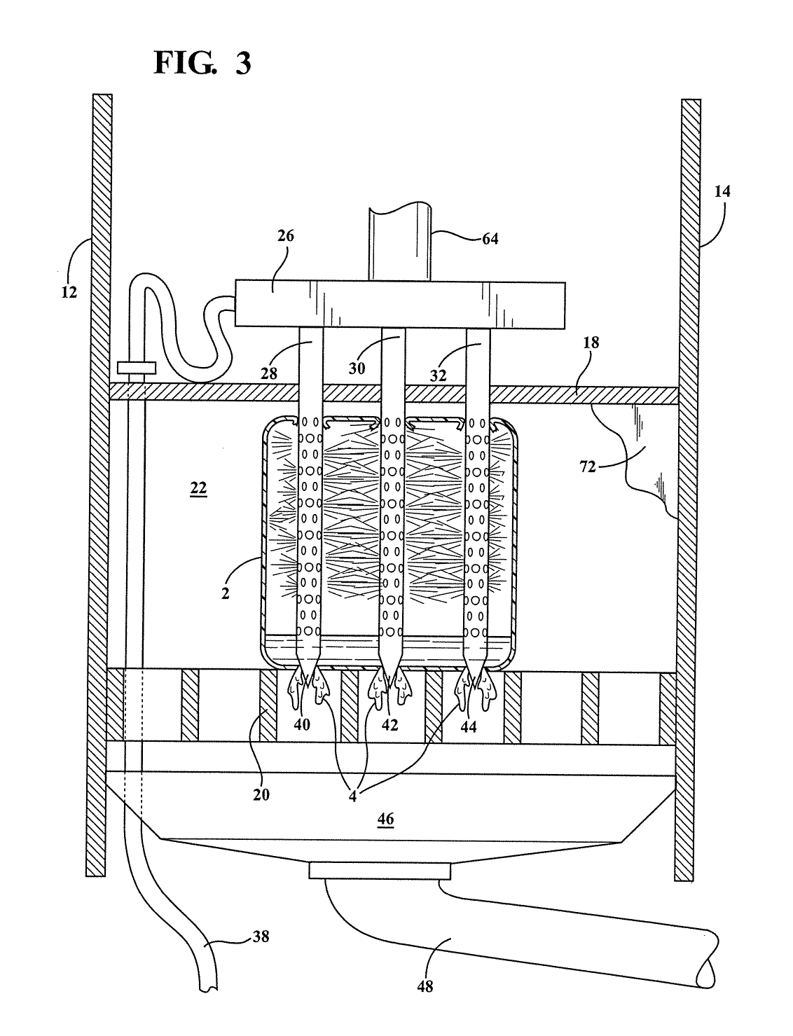

Without limitation, the trays 24/26 can be utilized solely to place or remove jugs to and from the receiving chamber 22 or can be additionally used to support the jugs during pre or post rinsing thereof, such as in order to remove addition contaminants residing on the exterior of the jugs. The jug 2 depicted in FIGS. 2-3 is shown with a rectangular cross section, such defining a 2.5 gallon reservoir, however it is understood that these can exhibit any suitable shape or volumetric holding capacity.

A jug piercing manifold 26 is positioned above the jug 2 placed within the receiving chamber 22 and includes any number of hollowed and fluid communicating spikes, see further at 28, 30, 32, etc., in FIGS. 2-3, for successively impaling and pressure washing the jug 2 or other container. A high pressure pump 34 draws fresh water or other cleaning fluid from a first proximately located tank or reservoir 36, via an inlet line 38. An outlet line 38 extends to the manifold 26 and to the impaling spikes 28, 30, 32, et seq. forming the displacing manifold.

As further best shown in each of the intermediate piercing view of FIG. 2 and the fully pierced view of FIG. 3, the pressurized fluid flows across the contaminated interior of the jug 2 and then out through a bottom of the container (typically laying on its side) which has been completely through punctured by pointed tips, further at 40, 42, 44 et seq. of the spikes 28, 30, 32. As further previously described, the floor (again at 20) of the jug receiving chamber is exhibited by a spaced grid or other apertured support surface which allows the tips 40, 42, 44 et seq. of the spikes 28, 30, 32, et seq. to pass unimpeded through the floor support to facilitate through drainage of the contaminated fluid, see at 4 in FIG. 3.

The contaminated fluid subsequently drains, via an underneath located collection pan 46 and connecting drain 48 into a second proximately located chemical rinse and storage tank 50 for secure disposal. As further shown in FIG. 1, both the first fresh water tank 36 and the second rinse tank 50 include top screw cap ports, at 52 and 54, respectively, these providing respectively for refill of emptying of the tanks. A sump pump 56 is also incorporated into the frame in fluid communication with the contaminated rinse tank, see line 58, for controlled drain disposal of the collected fluid.

An on/off switch 60 is secured to a visible location of the frame and, via an associated power supply and wiring (not shown) is configured for reciprocatingly displacing in bi-directional linear motion the manifold 26 and spikes 28, 30, 32, et seq. into successive piercing and retracting motions relative to each successively loaded jug within the receiving chamber. To this end, the horizontal support 18 above the receiving chamber 22 in turn supports a fixed cylinder 62 associated with the bi-directional linear drive, a reciprocating shaft 64 projecting downwardly from the cylinder 62 and supporting at its end the manifold 26 and plurality spikes 28, 30, 32, et seq. in downwardly projecting fashion.

Although not shown, it is understood that the manifold 26 receiving the pressurized fluid via the internal fluid conveying network (see again pressurized fluid line 38) is in communication with a hollow interior of each projecting spike, and typically by the interior of the manifold having a channel network communicating fluid flow to a hollow top inlet location for each of the spikes 28, 30, 32, et seq., these in turn being internally hollowed with perforations there along (further individual pluralities of which are best shown at 66, 68, 70 et seq. for spikes 28, 30, 32. et. seq) and for issuing the pressurized fluid within at least an interior of the pierced container as depicted in each of FIGS. 2-3.

As further depicted in each of FIGS. 1 and 3, the second horizontal support 18 located below the (generally flattened and plate shape) manifold 26 and allows for a complete range of reciprocating (typically bi-directional vertical) motion of the manifold and spikes through the support 18, an underside surface of the support 18 being further understood to be employed so as to forcibly dislodge the container from the spikes during (upward) retraction of the spikes through the second support 18. Without limitation, it is understood that additional embodiments may contemplate an arrangement in which a repositioned and reconfigured manifold is displaced either sideways or upwardly, yet additional embodiments envisioning the manifold being fixed and the container and its associated support surface being bi-directionally displaced both toward and away from the manifold and spikes.

Additional features include at least one extending side of the sealed enclosure defining the jug receiving chamber further including a transparent window (see partial designation at 72 in each of FIGS. 2-3). In a specific non-limiting embodiment, the at least one window can further be provided as a multi-sided plexi glass enclosure surrounding the jug receiving chamber, with first and second doors (these further depicted in non-limiting fashion as slide-up doors 74 and 76 in FIG. 1) configured within associated enclosure defining panels and communicating with the first 24 and second 26 trays.

Having described our invention, other and additional preferred embodiments will become apparent to those skilled in the art to which it pertains, and without deviating from the scope of the appended claims. This can include reconfiguring the frame and manifold such that the manifold can be caused to be fixed (thus dispensing with the need of a linear reciprocating drive), such instead being integrated into an elevator type arrangement associated with the floor grate or other support of the contaminated jug receiving chamber, and so that it can be caused to be vertically displaced into each of a first (elevating) contact with the downwardly arrayed spikes, following which the subsequent descending of the floor grate or support ensures that the jug is extracted from the spikes (this further accomplished by otherwise temporarily affixing or securing the jug to the floor grate in some secure manner.

Other variants can be provided without either or both of the first supply and second contaminated rinse collection tanks. This can include a city water inlet being directly communicated to the high pressure water pump and/or an outlet extending from the drain and to some other secure contaminated collection sink or reservoir (either with or without a sump pump as shown).

We claim:

1. A combination cleaning and disposal assembly for safely cleaning and rendering unusable a jug containing a hazardous chemical residue, comprising:
a body supporting a receiving chamber for receiving the jug;
a manifold supported by said body and having a plurality of spikes arrayed toward the jug;
a pressurized fluid source communicated to said manifold such that, upon a displacement occurring between said manifold and the container, said spikes being caused to pierce the container, the pressurized fluid being caused to issue from said spikes to clean an interior of the container; and
a drain located underneath the jug receiving chamber which collects and segregates the fluid contaminated with the chemical residue.

2. The assembly as described in claim 1, further comprising a reciprocating linear drive for displacing said manifold and spikes into successive piercing and retracting motions relative to each successively loaded jug within said receiving chamber.

3. The assembly as described in claim 2, said frame further comprising a horizontal support above said receiving chamber to which is secured a fixed cylinder associated with said linear drive, a reciprocating shaft projecting downwardly from said cylinder and supporting said manifold and plurality spikes in downwardly projecting fashion.

4. The assembly as described in claim 1, said pressurized fluid source further comprising a high pressure pump integrated into said body, a first conduit supplying the fluid into said pump, a second conduit supplying the pressurized fluid to said manifold.

5. The assembly as described in claim 4, further comprising a first fluid reservoir in communication with said first conduit.

6. The assembly as described in claim 1, further comprising said manifold receiving the pressurized fluid via an internal fluid conveying network in communication with a hollow interior of each projecting spike, said spikes being internally hollowed with perforations there along for issuing the pressurized fluid within at least an interior of the pierced container.

7. The assembly as described in claim 1, further comprising a collection tank in communication with said drain for receiving the contaminated rinse.

8. The assembly as described in claim 1, said body further comprising a structural frame within which is integrated said receiving chamber.

9. The assembly as described in claim 8, further comprising a first loading tray projecting from said tray in communication with said receiving chamber for introducing the contaminated jug into the receiving chamber.

10. The assembly as described in claim 9, further comprising a second jug removal tray located in communication with the receiving chamber on an opposite side from said first loading tray.

11. The assembly as described in claim 7, further comprising a sump pump in communication with said collection tank for controlled removal of the contaminated rinse.

12. The assembly as described in claim 1, the jug having a selected cross sectional shape such that it is placed in a side laying condition within said receiving chamber, said assembly further comprising a grate defining a floor of said receiving chamber upon which the jug is supported, tips of said spikes penetrating fully through the jug and between spaced apart supports of said grate to facilitate drainage of the contaminated fluid.

13. The assembly as described in claim 3, further comprising a second horizontal support located below said manifold and allowing for a complete range of reciprocating motion of said spikes through said second support, an underside surface of said second support forcibly dislodging the container from said spikes during retraction of said spikes upwardly and through said second support.

14. The assembly as described in claim 1, further comprising at least one transparent window defining a sealed enclosure surrounding said jug receiving chamber.

15. The assembly as described in claim 10, said at least one window further comprising a plexi glass enclosure surrounding the jug receiving chamber, first and second doors in said enclosure communicating with said first and second trays.

16. A combination cleaning and disposal assembly for safely cleaning and rendering unusable a jug containing a hazardous chemical residue, comprising:
a frame supporting a receiving chamber for receiving the jug;
a manifold supported by said body and having a plurality of spikes arrayed toward the jug;
a reciprocating linear drive for displacing said manifold and spikes into successive piercing and retracting motions relative to each successively loaded jug within said receiving chamber;
a horizontal support above said receiving chamber to which is secured a fixed cylinder associated with said linear drive, a reciprocating shaft projecting downwardly from cylinder and supporting said manifold and plurality spikes in downwardly projecting fashion;
a pressurized fluid source communicated to said manifold such that, upon a downward displacement of said manifold, said spikes being caused to pierce the container, the pressurized fluid being caused to issue from said spikes to clean an interior of the container;
a second horizontal support located below said manifold and allowing for a complete range of reciprocating motion of said spikes through said second support, an underside surface of said second support forcibly dislodging the container from said spikes during retraction of said spikes upwardly and through said second support; and
a drain located underneath the jug receiving chamber which collects and segregates the fluid contaminated with the chemical residue.

17. The assembly as described in claim 16, further comprising said manifold receiving the pressurized fluid via an internal fluid conveying network in communication with a hollow interior of each projecting spike, said spikes being internally hollowed with perforations there along for issuing the pressurized fluid within at least an interior of the pierced container.

18. The assembly as described in claim 16, further comprising a collection tank in communication with said drain for receiving the contaminated rinse.

19. The assembly as described in claim 16, the jug having a selected cross sectional shape such that it is placed in a side laying condition within said receiving chamber, said assembly further comprising a grate defining a floor of said receiving chamber upon which the jug is supported, tips of said spikes penetrating fully through the jug and between spaced apart supports of said grate to facilitate drainage of the contaminated fluid.

20. The assembly as described in claim 16, further comprising a first loading tray projecting from said tray in communication with said receiving chamber for introducing the contaminated jug into the receiving chamber, a second jug removal tray located in communication with the receiving chamber on an opposite side from said first loading tray.
